(19) United States
(12) Patent Application Publication
(10) Pub. No.: US 2022/0322230 A1
(43) Pub. Date: Oct. 6, 2022

(54) Power Saving for User Equipment Through Sidelink Scheduling Offloading

(71) Applicant: Apple Inc., Cupertino, CA (US)

(72) Inventors: Chunxuan Ye, San Diego, CA (US); Chunhai Yao, Beijing (CN); Dawei Zhang, Saratoga, CA (US); Haitong Sun, Irvine, CA (US); Hong He, Cupertino, CA (US); Huaning Niu, San Diego, CA (US); Jia Tang, San Jose, CA (US); Oghenekome Oteri, San Diego, CA (US); Seyed Ali Akbar Fakoorian, San Diego, CA (US); Sigen Ye, Whitehouse Station, NJ (US); Wei Zeng, San Diego, CA (US); Weidong Yang, San Diego, CA (US); Yushu Zhang, Beijing (CN)

(21) Appl. No.: 17/438,905

(22) PCT Filed: Oct. 21, 2020
(86) PCT No.: PCT/CN2020/122446

§ 371 Date: Sep. 13, 2021

(51) Int. Cl. H04W 52/02

(52) U.S. Cl. CPC H04W 52/0216; H04W 52/0225

(57) ABSTRACT

A user equipment (UE) configured to transmit a scheduling request (SR) to a second UE which causes the second UE to determine a set of sidelink transmission resources for use by the UE. The UE may then receive information regarding a determined set of sidelink transmission resources from the second UE and then transmit sidelink communications using at least a subset of the determined set of sidelink transmission resources. The determined set of sidelink transmission resources may be recommended and reserved or non-reserved resources. The UE may transmit configuration information concerning transmission resources to the second UE to be used in transmitting, the SR. The second UE may monitor the channel for arrival of the resources. The SR may be encoded as a cyclic shift of the SR corresponding to an ACK-only sequence, an ACK/NACK sequence, or a certain sequence of the SR based on a configuration index.

### FIELD

The present application relates to wireless devices, and more particularly to an apparatus, system, and method for scheduling and allocating sidelink resources of wireless devices with varying power capabilities in order to reduce latency and power consumption and enhance reliability.

### DESCRIPTION OF THE RELATED ART

Wireless communication systems are rapidly growing in usage. One proposed use of wireless communications is in vehicular applications, particularly in V2X (vehicle-to-everything) systems. V2X systems allow for communication between vehicles (e.g., via communications devices housed in or otherwise carried by vehicles), pedestrian UEs (including UEs carried by other persons such as cyclists, etc.), and other wireless communications devices for various purposes, such as to coordinate traffic activity, facilitate autonomous driving, and perform collision avoidance.

The increased communication requirements of certain V2X systems may strain the power and resource capabilities of portable, battery-powered UE devices. In addition, some UEs are more power limited than others and communicating with a host of UEs may present decreased battery life, increased latency, and degraded communication issues. Accordingly, improvements in the field would be desirable.

### SUMMARY

Embodiments are presented herein of apparatuses, systems, and methods for a wireless device to offload scheduling and allocation of sidelink resources to another higher-powered wireless device in order to reduce latency and power consumption and enhance reliability.

Some embodiments relate to a user equipment (UE), comprising at least one antenna, a radio operably coupled to the at least one antenna a processor operably coupled to the radio. The UE (first UE) may be configured to transmit a scheduling request to a second UE which causes the second UE to determine a set of sidelink transmission resources for use by the first UE. In other words, the first UE may offload the task of determining its available sidelink resources to the second UE, which may have higher power capabilities relative to the first UE. In response to this scheduling request, the second UE may determine a set of sidelink resources that are available for the first UE to use, e.g., by sensing traffic on the sidelink channel. The second UE may then provide these determined sidelink resources to the first UE. In some aspects, the second UE may monitor the channel for arrival of the resources. Thus, the first UE may receive information regarding a determined set of sidelink transmission resources from the second UE, wherein the set of sidelink resources are determined by the second UE based on the transmitted scheduling request. Finally, the first UE may then transmit sidelink communications using at least a subset of the determined set of sidelink transmission resources indicated by the second UE.

In some aspects, the determined set of sidelink transmission resources may be recommended (not reserved) resources. Conversely, in other aspects, the determined set of sidelink transmission resources may be reserved by the second UE for use by the first UE.

Additionally, one or both of the first and second UEs described above may be further configured to exchange configuration information with the other, in which the configuration information configures transmission resources used in transmitting the scheduling request.

The sidelink scheduling request (S-SR) may be encoded as a cyclic shift of the S-SR corresponding to an ACK-only sequence or an ACK/NACK sequence. In some embodiments, the scheduling request may be encoded as a configuration index which indicates a certain sequence of the S-SR.

Some embodiments may relate to a user equipment (UE) device having at least one antenna for performing wireless communications, a radio, and a processing element coupled to the radio. The UE may perform at least some of the methods described herein.

Some embodiments relate to a baseband processor having processing circuitry configured to perform at least a portion or all of the above operations.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which;

FIG. 1 illustrates an example vehicle-to-everything (V2X) communication system, according to some embodiments;

FIG. 2 illustrates a base station in communication with a user equipment (UE) device, according to some embodiments;

FIG. 3 is an example block diagram of a UE, according to some embodiments;

FIG. 4 is an example block diagram of a base station, according to some embodiments;

FIG. 5 illustrates an example of a vehicle-to-everything network, according to some embodiments;

FIG. 6 illustrates an example procedure of a slave UE data transmission, according to some embodiments;

FIG. 7 illustrates an example procedure of a master UE data transmission, according to some embodiments;

FIG. 8 illustrates an example structure of a sidelink scheduling request (S-SR) signal, according to some embodiments;

FIG. 9 illustrates the frequency and code resources of a sidelink scheduling request (S-SR) signal, according to some embodiments;

FIG. 10 illustrates an example of a master UE providing a slave UE with recommended but not reserved resources, according to some embodiments;

FIG. 11 illustrates an example of a master UE providing a slave UE with recommended and reserved resources, according to some embodiments;

While the features described herein may be susceptible to various modifications and alternative forms, specific embodiments thereof are shown by way of example in the drawings and are herein described in detail. It should be understood, however that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

Various acronyms are used throughout the present disclosure. Definitions of the most prominently used acronyms that may appear throughout the present disclosure are provided below:

UE: User Equipment

RF: Radio Frequency

BS: Base Station

GSM: Global System for Mobile Communication

UMTS: Universal Mobile Telecommunication System

LTE: Long Term Evolution

NR: New Radio

NR-U: NR Unlicensed

TX: Transmission/Transmit

RX: Reception/Receive

RAT: Radio Access Technology

TRP: Transmission-Reception-Point

DCI: Downlink Control Information

V2X: Vehicle to Everything

PSCCH: Physical Sidelink Control Channel

PSSCH: Physical Sidelink Shared Channel

PUCCH: Physical Uplink Control Channel

S-SR: Sidelink Scheduling Request

PUE: Pedestrian User Equipment

VUE: Vehicular User Equipment

SL: Sidelink

MCS: Modulation and Coding Scheme

DMRS: Demodulation Reference Signal

RO: Resource Occupancy

RSU: Roadside Unit

SPS: Semi-Persistent Scheduling

QoS: Quality of Service

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the, first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Device—as used herein, may refer generally in the context of V2X systems to devices that are associated with mobile actors or traffic participants in a V2X system, i.e., mobile (able-to-move) communication devices such as vehicles and pedestrian user equipment (PUE) devices, as opposed to infrastructure devices, such as base stations, roadside units (RSUs), and servers.

Infrastructure Device—as used herein, may refer generally in the context of V2X systems to certain devices in a V2X system that are not user devices, and are not carried by traffic actors (i.e., pedestrians, vehicles, or other mobile users), but rather that facilitate user devices' participation in the V2X network. Infrastructure devices include base stations and roadside units (RSUs).

User Equipment (UE) (or “UE Device”)—any of various types of computer systems devices which are mobile or portable and which perform wireless communications. Examples of UE devices include mobile telephones or smartphones (e.g., iPhone™, Android™-based phones), portable gaming devices (e.g., Nintendo DS™, PlayStation Portable™, Gameboy Advance™, iPhone™), laptops, wearable devices (e.g. smartwatch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Pedestrian UE (PUE) Device—a user equipment (UE) device that may be worn or carried by various persons, including not only pedestrians in the strict sense of persons walking near roads, but also certain other peripheral or minor participants, or potential participants, in a traffic environment. These include stationary persons, persons not on vehicles who may not necessarily be near traffic or roads, persons jogging, running, skating, and so on, or persons on vehicles that may not substantially bolster the power capabilities, such as bicycles, scooters, or certain motor vehicles. Examples of pedestrian UEs include smart phones, wearable UEs, PDAs, etc,

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

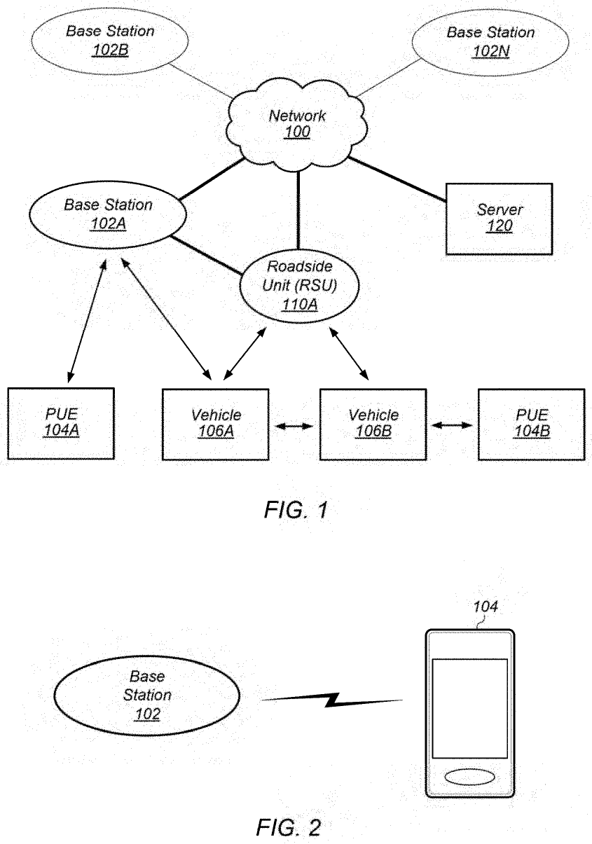

### FIG. 1—V2X Communication System

FIG. 1 illustrates an example vehicle-to-everything (V2X) communication system, according to some embodiments. It is noted that the system of FIG. 1 is merely one example of a possible system, and that features of this disclosure may be implemented in any of various systems, as desired.

Vehicle-to-everything (V2X) communication systems may be characterized as networks in which vehicles, UEs, and/or other devices and network entities exchange communications in order to coordinate traffic activity, among other possible purposes. V2X communications include communications conveyed between a vehicle (e.g., a wireless device or communication device constituting part of the vehicle, or contained in or otherwise carried along by the vehicle) and various other devices. V2X communications include vehicle-to-pedestrian (V2P), vehicle-to-infrastructure (V2I), vehicle-to-network (V2N), and vehicle-to-vehicle (V2V) communications, as well as communications between vehicles and other possible network entities or devices. V2X communications may also refer to communications between other non-vehicle devices participating in a V2X network for the purpose of sharing V2X-related information.

V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short- to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATS. Certain LTE standards usable in V2X systems may be called LTE-Vehicle (LTE-V) standards.

As shown, the example V2X system includes a number of user devices. As used herein in the context of V2X systems, and as defined above, the term “user devices” may refer generally to devices that are associated with mobile actors or traffic participants in the V2X system i.e., mobile (able-to-move) communication devices such as vehicles and pedestrian user equipment (PUE) devices. User devices in the example V2X system include the PUEs 104A and 104B and the vehicles 106A and 106B.

The vehicles 106 may constitute various types of vehicles. For example, the vehicle 106A may be a road vehicle or automobile, a mass transit vehicle, or another type of vehicle. The vehicles 106 may conduct wireless communications by various means. For example, the vehicle 106A may include communications equipment as part of the vehicle or housed in the vehicle, or may communicate through a wireless communications device currently contained within or otherwise carried along by the vehicle, such as a user equipment (UE) device (e.g., a smartphone or similar device) carried or worn by a driver, passenger, or other person on board the vehicle, among other possibilities. For simplicity, the term “vehicle” as used herein may include the wireless communications equipment which represents the vehicle and conducts its communications. Thus, for example, when the vehicle 106A is said to conduct wireless communications, it is understood that, more specifically, certain wireless communications equipment associated with and carried along by the vehicle 106A is performing the wireless communications.

The pedestrian UEs (PUEs) 104 may constitute various types of user equipment (UE) devices, i.e., portable devices capable of wireless communication, such as smartphones, smartwatches, etc., and may be associated with various types of users. Thus, the PUEs 104 are UEs, and may be referred to as UEs or UE devices. Note that although the UEs 104 may be referred to as PUEs (pedestrian UEs), they may not necessarily be carried by persons who are actively walking near roads or streets. PUEs may refer to UEs participating in a V2X system that are carried by stationary persons, by persons walking or running, or by persons on vehicles that may not substantially bolster the devices' power capabilities, such as bicycles, scooters, or certain motor vehicles. Note also that not all UEs participating in a V2X system are necessarily PUEs.

The user devices may be capable of communicating using multiple wireless communication standards. For example, the UE 104A may be configured to communicate using a wireless networking (e.g., Wi-Fi) and/or peer-to-peer wireless communication protocol (e.g., Bluetooth, Wi-Fi peer-to-peer, etc.) in addition to at least one cellular communication, protocol (e.g., GSM, UMTS, LTE, LTE-A, LTE-V, HSPA, 3GPP2 CDMA2000, 5G NR, etc.). The UE 104A may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

As Shown, certain user devices may be able to conduct communications with one another directly, i.e., without an intermediary infrastructure device such as base station 102A or RSU 110A. As shown, vehicle 106A may conduct V2X-related communications directly with vehicle 106B. Similarly, the vehicle 106B may conduct V2X-related communications directly with PUE 104B. Such peer-to-peer communications may utilize a “sidelink” interface such as the PC5 interface in the case of some LTE and/or 5G NR embodiments. In some embodiments, the PC5 interface supports direct cellular communication between user devices (e.g., between vehicles 106), while the Uu interface supports cellular communications with infrastructure devices such as base stations. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations. Some user devices in a V2X system, e.g., PUE 104A, may be unable to perform sidelink communications, e.g., because they lack certain hardware necessary to perform such communications.

As shown, the example V2X system includes a number of infrastructure devices in addition to the above-mentioned user devices. As used herein, “infrastructure devices” in the context of V2X systems refers to certain devices in a V2X system which are not user devices, and are not carried by traffic actors (i.e., pedestrians, vehicles, or other mobile users), but rather which facilitate user devices' participation in the V2X network. The infrastructure devices in the example V2X system include base station 102A and roadside unit (RSU) 110A.

The base station (BS) 102A may be a base transceiver station (BTS) or cell site (a “cellular base station”), and may include hardware that enables wireless communication with user devices, e.g., with the user devices 104A and 106A.

The communication area (or coverage area) of the base station may be referred to as a “cell” or “coverage”. The base station 102A and user devices such as PUE 104A may be configured to communicate over the transmission medium using any of various radio access technologies (RATs), also referred to as wireless communication technologies, or telecommunication standards, such as GSM, UMTS, LTE, LTE-Advanced (LTA-A), LTE-Vehicle (LTE-V), HSPA, 3GPP2 CDMA2000, 5G NR, etc. Note that if the base station 102A is implemented in the context of LTE, it may alternately be refined to as an ‘eNodeB’, or eNB whereas if the base station 102A is implemented in the context of 5G NR, it may alternately be referred to as a ‘gNodeB’, or gNB.

As shown, the base station 102A may also be equipped to communicate with a network 100 (e.g., the V2X network, as well as a core network of a cellular service provider, a telecommunication network such as a public switched telephone network (PSTN), and/or the Internet, among various possibilities). Thus, the base station 102A may facilitate communication between user devices and/or between user devices and the network 100. The cellular base station 102A may provide user devices, such as UE 104A, with various telecommunication capabilities, such as voice, SMS and/or data services. In particular, the base station 102A may provide connected user devices, such as UE 104A and vehicle 106A, with access to the V2X network.

Thus, while the base station 102A may act as a “serving cell” for user devices 104A and 106A as illustrated in FIG. 1, the user devices 104B and 106B may also be capable of communicating with the base station 102A. The user devices shown, i.e., user devices 104A, 104B, 106A, and 106B may also be capable of receiving signals from (and may possibly be within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are of course also possible.

Roadside unit (RSU) 110A constitutes another infrastructure device usable for providing certain user devices with access to the V2X network. RSU 110A may be one of various types of devices, such as a base station, e.g., a transceiver station (BTS) or cell site (a “cellular base station”), or another type of device that includes hardware that enables wireless communication with user devices and facilitates their participation in the V2X network.

RSU 110A may be configured to communicate using one or more wireless networking communication protocols (e.g., Wi-Fi), cellular communication protocols (e.g., LTE, LTE-V, 5G NR, etc.), and/or other wireless communication protocols. In some embodiments, RSU 110A may be able to communicate with devices using a “sidelink” technology such as PC5.

RSU 110A may communicate directly with user devices, such as the vehicles 106A and 106B as shown. RSU 110A may also communicate with the base station 102A. In some cases, RSU 110A may provide certain user devices, e.g., vehicle 106B, with access to the base station 102A. While RSU 110A is shown communicating with vehicles 106, it may also (or otherwise) be able to communicate with PUEs 104. Similarly, RSU 110A may not necessarily forward user device communications to the base station 102A. In some embodiments, the RSU 110A and may constitute a base station itself, and/or may forward communications to the server 120.

The server 120 constitutes a network entity of the V2X system, as shown, and may be referred to as a cloud server. Base station 102A and/or RSU 110A may relay certain V2X-related communications between the user devices 104 and 106 and the server 120. The server 120 may be used to process certain information collected from multiple user devices, and may administer V2X communications to the user devices in order to coordinate traffic activity. In various other embodiments of V2X systems, various functions of the cloud server 120 may be performed by an infrastructure device such as the base station 102A or RSU 110A, performed by one or more user devices, and/or not performed at all.

### FIG. 2—Communication Between a UE and Base Station

FIG. 2 illustrates a user equipment (UE) device 104 (e.g., one of the PUEs 104A or 104B in FIG. 1) in communication with a base station 102 (e.g., the base station 102A in FIG. 1), according to some embodiments. The UE 104 may be a device with cellular communication capability such as a mobile phone, a hand-held device, a computer or a tablet, or virtually any type of portable wireless device.

The UE 104 may include a processor that is configured to execute program instructions stored in memory. The UE 104 may perform any of the method embodiments described herein by executing such stored instructions. Alternatively, or in addition, the UE 104 may include a programmable hardware element such as an FPGA (field-programmable gate array) that is configured to perform any of the method embodiments described herein, or any portion of any of the method embodiments described herein.

The UE 104 may include one or more antennas for communicating using one or more wireless communication protocols or technologies. In some embodiments, the UE 104 may be configured to communicate using, for example, CDMA2000 (1xRTT/1xEV-DO/HRPD/eHRPD), LTE, and/or 5G NR using a single shared radio and/or 5G NR or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 104 may share one or more parts of a receive and/or transmit chain between multiple wireless communication technologies, such as those discussed above.

In some embodiments, the UE 104 may include separate transmit and/or receive chains (e.g., including separate antennas and other radio components) for each wireless communication protocol with which it is configured to communicate. As a further possibility, the UE 104 may include one or more radios which are shared between multiple wireless communication protocols, and one or more radios which are used exclusively by a single wireless communication protocol. For example, the UE 104 might include a shared radio for communicating using any of 5G NR, LTE and/or 1xRTT (or LTE or GSM), and separate radios for communicating using each of Wi-Fi and Bluetooth. Other configurations are also possible.

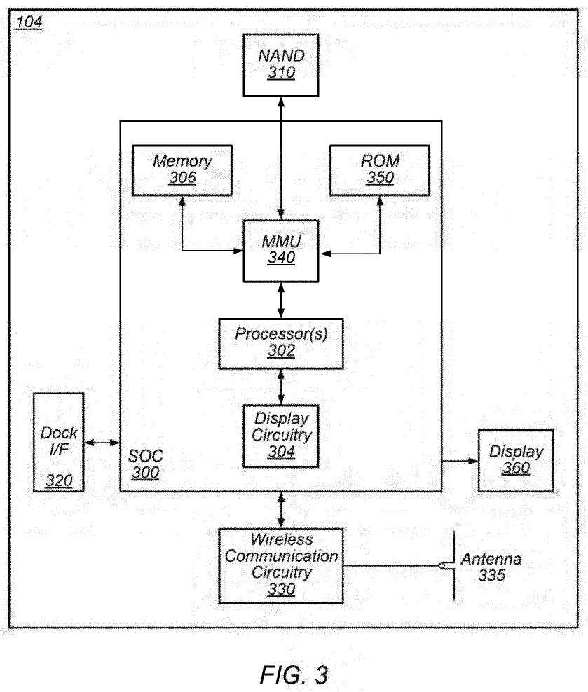

### FIG. 3—UE Block Diagram

FIG. 3 illustrates an example block diagram of a UE 104, according to some embodiments. As shown, the UE 104 may include a system on chip (SOC) 300, which may include portions for various purposes. For example, as shown, the SOC 300 may include processor(s) 302 which may execute program instructions for the UF 104 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 104. For example, the UE 104 may include various types of memory (e.g., including, NAND flash memory 310), a connector interface 320 (e.g., for coupling to a computer system, dock, charging station, etc.), the display 360, and wireless communication circuitry 330 (e.g., for LTE, LTE-A, LTE-V, 5G NR, CDMA2000, Bluetooth, Wi-Fi, GPS, etc.). The UE may also include at least one SIM device, and may include two SIM devices, each providing a respective international mobile subscriber identity (IMSI) and associated functionality.

As shown, the UE device 104 may include at least one antenna (and possibly multiple antennas, e.g., for MIMO and/or for implementing different wireless communication technologies, among various possibilities) for performing wireless communication with base stations, access points, and/or other devices. For example, the UE device 104 may use antenna 335 to perform the wireless communication.

The UE 104 may also include and/or be configured for use with one or more user interface elements. The user interface elements may include any of various elements, such as display 360 (which may be a touchscreen display), a keyboard (which may be a discrete keyboard or may be implemented as part of a touch screen display), a mouse, a microphone and/or speakers, one or more cameras, one or more buttons, and/or any of various other elements capable of providing information to a user and/or receiving or interpreting user input.

As described herein, the UE 104 may include hardware and software components for implementing features for performing more efficient vehicle-related communication, such as those described herein. The processor 302 of the UE device 104 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC Application Specific integrated Circuit). Alternatively (or in addition) the processor 302 of the UE device 104, in conjunction with one or more of the other components 300, 304, 306, 310, 320, 330, 335, 340, 350, 360 may be configured to implement part or all of the features described herein, such as the features described herein.

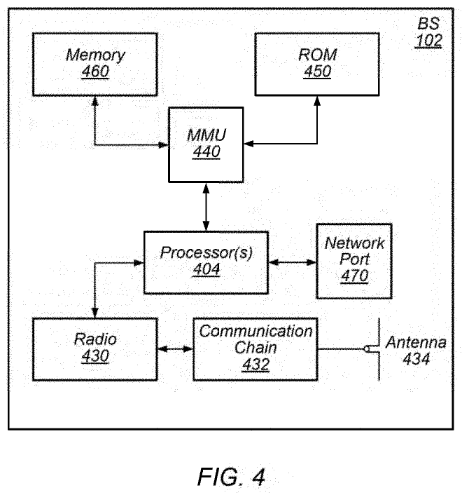

### FIG. 4—Base Station Bock Diagram

FIG. 4 illustrates an example block diagram of a base station 102 (e.g., base station 102A in FIG. 1), according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 104 access to the telephone network

The network port 470 (or an additional network port) may also or alternatively be configured to couple to a cellular network, e.g., a core network of a cellular service provider. The core network may provide mobility related services and/or other services to a plurality of devices, such as UE devices 104. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 104 via radio 430. The antenna 434 communicates with the radio 430 via communication chain 432. Communication chain 432 may be a receive chain, a transmit chain or both. The radio 430 may be configured to communicate via various wireless communication standards, including, but not limited to, LTE, LTE-A, LTE-V, GSM, UMTS, CDMA2000, 5G NR, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing, communication according to LTE as well as a 5G NR radio for performing communication according to 5G NR. In such a case, the base station 102 may be capable of operating as both an LTE base station and a 5G NR base station. As another example, the base station 102 may include a 5G NR radio for performing communication according to 5G NR as well as a Wi-Fi radio for performing communication according to Wi-Fi. In such a case, the base station 102 may be capable of operating as both 5G NR base station and a Wi-Fi access point. As a further possibility, the base station 102 may include a multi mode radio which is capable of performing communications according to any of multiple wireless communication technologies (e.g., LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102 in conjunction with one or more of die other components 430, 432, 434, 440, 450, 460, 470 may be configured to implement or support implementation of part or all of the features described herein.

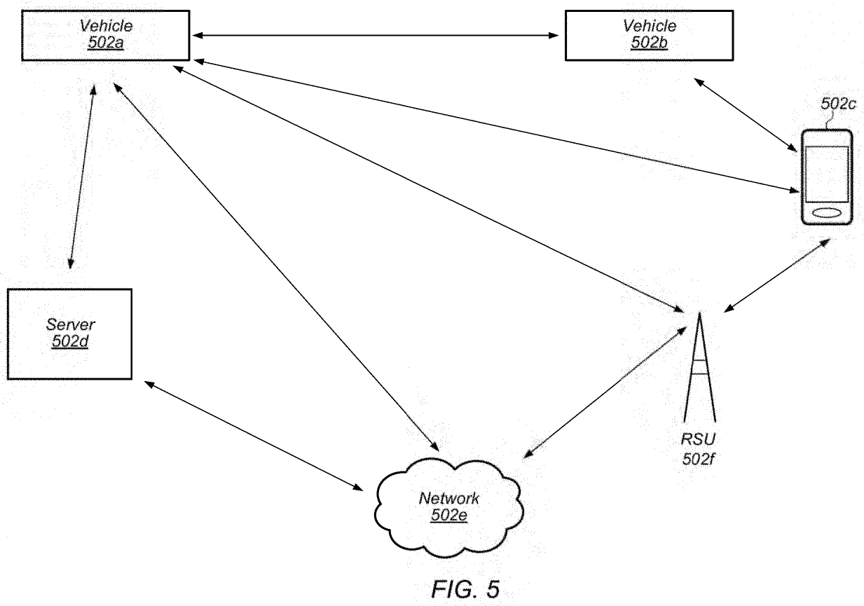

### FIG. 5—Sidelink Resource Management

As noted above, certain user devices (or UE devices) may be able to conduct communications with one another directly, i.e., without an intermediary infrastructure device such as base station 102A or RSU 110A. This direct communication between two wireless devices, such as between two vehicles, or between a vehicle UE and a pedestrian UE, is referred to as sidelink communication. Stated another way, two UE devices performing peer-to-peer (direct) communications with each other may each utilize a “sidelink” interface and may be said to be communicating over a sidelink channel.

In some existing implementations, a listen before talk (LBT) mechanism may be used to access the shared medium (e.g., such as unlicensed bands commonly used for Wi-Fi, Bluetooth, and other short to medium range communications, e.g., non-3GGP access) during sidelink communications to avoid collisions (e.g., of transmissions emanating from two or more wireless devices attempting to access the shared medium) and to improve medium utilization efficiency. However, LBT mechanisms are not collision free. In other words, LBT mechanisms cannot guarantee collision free transmissions.

For example, in the case of a uni-cast transmission a transmitter may readily detect a transmission collision based on a receiver's acknowledgement/negative acknowledgement (ACK/NACK) feedback. However, in the case of a multi-cast (or group-cast) transmission, a transmitter may not easily detect a collision based on receivers' ACK/NACKs due, at least in part, to heavy traffic associated with ACK/NACKs from multiple receivers and to a transmitter's inability to distinguish between (or isolate) transmission collisions from channel quality issues based on received ACK/NACKS. In other words, since receivers in a multi-cast transmission may have different locations with differing channel quality, a reason for a NACK (e.g., transmission collision versus poor channel quality) cannot be determined by the transmitter. Additionally, in the case of a broadcast transmission, feedback from receivers is known to not be feasible, so in this scenario, a transmitter would not have knowledge of collisions. Further, in some implementations, a transmitter may reserve periodic slots within a reservation period for communication. In such implementations, if collisions occur, the collisions could persist for at least a portion of the reservation period (and in a worst-case scenario, the duration of the reservation period) if the transmitter does not detect (or is unable to detect) the collisions.

As an example, vehicle-to-everything (V2X) communications, e.g., as specified by 3GPP TS 22.185 V.14.3.0, allows for communication between a vehicle (e.g., a mobile unit within a vehicle, such as a wireless device comprised within or currently contained within a vehicle and/or another transmitter contained or comprised with a vehicle) and various wireless devices. For example, as illustrated by FIG. 5, a vehicle, such as vehicle 502a, may communicate with various devices (e.g., devices 502b-f), such as road side units (RSUs), infrastructure (V2I), network (V2N), pedestrian (V2P), and/or other vehicles (V2V). In addition, as shown, various devices within the V2X framework may communicate with other devices. V2X communications may utilize both long range (e.g., cellular) communications as well as short to medium range communications (e.g., non-cellular). In some contemplated implementations, the non-cellular communications may use unlicensed bands as well as a dedicated spectrum at 5.9 GHz. Moreover, V2X communications may include uni-cast, multi-cast, groupcast, and/or broadcast communications. Each communication type may employ an LBT mechanism. Further, under the V2X communication protocol, a transmitter may reserve periodic slots within a reservation period. Thus, as described above, in various cases a transmitter V2X communications, may, in some instances, be unable to detect collisions after using an LBT mechanism.

In order to help prevent collisions on the shared sidelink channel, the various UEs in a network (e.g., a V2X network) may perform sidelink resource management for both network assisted resource management and autonomous (e.g non-network assisted) resource management. In other words, the various UE devices may operate to determine or schedule the use of sidelink resources for transmissions to other UEs. In some embodiments, a UE, such as UE 106, may originate a semi-persistent sidelink schedule for a resource. A UE may broadcast a resource occupancy message (RO message) periodically. The RO message may include resource blocks (RBs) and/or sub-frames to be used (scheduled), a periodicity of resource occupancy (e.g., reservation), and/or, a time remaining for the resource occupancy (e.g., reservation). In addition, in some embodiments, a maximum allowed channel occupancy time (T_max_COT) may be defined. In such embodiments, an initial remaining time of the resource occupancy may not exceed the maximum allowed channel occupancy time, in other words, the resource occupancy may only be for a time less than the maximum allowed, channel occupancy time.

In some embodiments, when a UE enters a new system (e.g., a new set of UEs and/or a new location), the UE may sense (listen) to a channel to collect existing UEs RO messages to determine available resources in the new system. In other words, prior to transmitting a RO message when entering a new set of UEs/area (e.g., a set of UEs with proximity for sidelink communications), the UE may determine available resources via reception of RO messages from neighboring UEs. In some embodiments, upon expiration of a resource occupancy, a UE, prior to transmitting a new RO message, may determine available resources via reception of RO messages from neighboring UEs.

### Power Saving for User Equipment Through Sidelink Scheduling Requests and Resource Allocation

In some existing implementations, 5G NR V2X may include various scheduling modes. For example, 5G NR V2X mode 2 may be designed for UE self-determination of sidelink transmission resources. 5G NR V2X mode 2 includes various sub-modes, including;

Mode 2(a) in which a user equipment device (UE) autonomously selects sidelink resources for transmission;

Mode 2(b) in which a UE assists sidelink resource selection for other UE(s);

Mode 2(c) in which a UE is configured with NR configured grants (e.g., network defined semi-persistent grants) for sidelink transmission; and

Mode 2(d) in which a UE schedules sidelink transmissions of other UEs. In addition, due to the periodic nature of V2X messaging, existing implementations of V2X may support semi-persistent scheduling (SPS), e.g., configured grant(s). For example, semi-persistent resources in SPS may represent timely repeated resources across a set of discontinuous sub-frames with a certain repetition periodicity. Semi-persistent resources may be scheduled across a set of discontinuous sub-frames with a sub-frame repetition period. Further, existing implementations of SPS (e.g., LTE V2X) and its corresponding resource allocation design are optimized for broadcast service. However, 5G NR V2X mode 2 additionally supports both unicast and groupcast services. Thus, there is a strong need to enhance methods that aid semi-persistent resource allocation for unicast service and groupcast service in 5G NR V2X mode 2.

In NR V2X R16, both Mode 1 and Mode 2 resource allocation schemes may be supported. The Mode 2 resource allocation scheme may involve the transmitting UE selecting the sidelink transmission resources based on its own sensing and resource selection procedure. In Rel-17 sidelink enhancement, the objective is to specify resource allocation by introducing the principle of Rel-14 LTE sidelink random resource selection and partial sensing to Rel-16 NR sidelink resource allocation Mode 2.

As noted above, when using mode 2 some UEs may need to periodically perform sensing operations on the sidelink channel with a relatively high frequency in order to identify and utilize the potential resources of other UEs for sidelink communication. Such active sensing may consume device resources, e.g., power, at a relatively high rate. However, the option to reduce the sensing operations to a state of partial sensing (such as the UE only monitoring a subset of the subframes it is receiving) still consumes energy. Even further, the option to perform no sensing (e.g. random resource selection) may have a high resource collision probability.

This potentially high resource usage and potentially high rate of power consumption may heavily burden certain devices participation in the V2X system. This high resource usage may be less of a concern for infrastructure devices such as base stations and roadside units (RSUs), which may have extensive resource and power capabilities, e.g., which are not battery powered. Similarly, it may be less of a concern for certain vehicle devices which may also have access to extensive power capabilities. However, the potentially high-power consumption involved with sensing the sidelink channel for available sidelink resources, as well as other V2X communications, may overburden certain handheld or portable battery-powered devices participating in the V2X network, i.e., certain user equipment (UE) devices, UEs in the V2X system may be UEs carried or worn by pedestrians or other persons, where the term pedestrian UE (PUE) includes UEs carried by persons who may be stationary, walking, running, cycling, etc., as described above.

Hence, for V2X systems that involve UEs, which are generally resource-limited (battery powered and hence power limited), and particularly PUEs, improved power conservation and communication techniques may be desired. This is particularly true for more highly power limited devices, such as wearable UEs, smart watch or smart glasses.

In some embodiments, a first UE, referred to as a “slave UE”, may request to offload the task of determining are sidelink resources to a second UE, referred to as the “master UE”. The request made by the first UE may be in the form of a scheduling request. Stated another way, the first UE may be power limited and seek to reduce power consumption by offloading some communication or sensing responsibilities to a less power limited master UE. In order to offload said responsibilities, the first UE transmits a sidelink scheduling request to the master UE. More specifically, the establishment of the sidelink scheduling request allows for inter-UE coordination between the master UE and slave UE, enabling the master UE to communicate and instruct the first UE with regard to resource allocation and sensing protocols. An example of inter-UE coordination might be that a set of resources is determined by the master UE (UE-B. This set is then sent to the first UE (UE-A) (operating in Mode 2), and UE-A then takes this received resource set into account in the resource selection for its own transmission. The effect of this inter-UE coordination is intended to result in reduced power consumption and latency of the first UE in addition to enhanced reliability through the shared or directed responsibilities pertaining to resource allocation and sensing.

In some embodiments, the slave UE may be power limited and attempt to connect to a master UE in order to receive scheduling information, i.e., to offload the task of determining its scheduling information. The master if may have more available power than the slave UE and thus may provide scheduling information to the slave UE to reduce the power utilization of the slave UE. As one example, the master UE may not be power limited, e.g., the master UE may be a vehicle UE or RSU. Alternatively the master UE may also be power limited but may have more relaxed power limitations. For example, the slave UE may be a wearable device such as a smart watch, and the master UE may be a smart phone. Further, the master and slave relationship previously described should not be limited to the example above referring to a wearable device slave UE, such as a smart watch, and a smart phone master UE, or a smart phone slave UE and a master VUE. Moreover, the connection between a slave UE and master UE does not have to be one-to-one. In some aspects, multiple slave UEs may be connected with a single master UE and in other embodiments, multiple master UEs may be connected with a single slave UE.

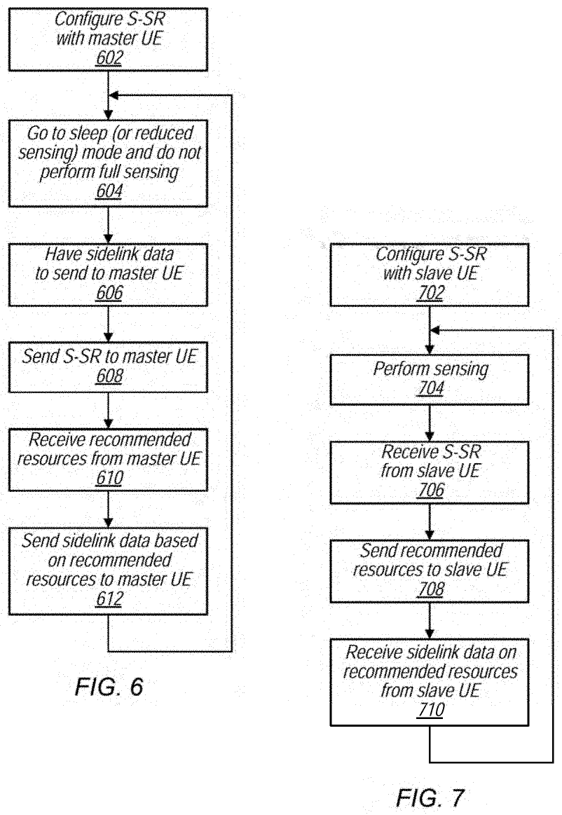

### FIG. 6—Slave UE Data Transmission

FIG. 6 illustrates an exemplary procedure of slave UE data transmission, according to some embodiments.

First, in step 602, the slave UE may transmit sidelink scheduling configuration information with a master UE in order to configure the master/slave communications between them. The sidelink scheduling configuration information may be contained in sidelink control information (SCI) and may detail resource block assignment, modulation and coding schemes, Group Destination ID (for sidelink communication) and ProSe Per-Packet Priority (PPPP, for V2X sidelink communication), for example. Additionally, the configuration of the sidelink scheduling request (S-SR) may involve a pair of UEs needing to configure a particular S-SR resource, i.e., a resource to be used for future transmission of a scheduling request (offloading request), which may be comprised of time resources, frequency resources, or coding information.

The S-SR resource configuration may also include information pertaining to the slot offset values to be configured, periodicity of the S-SR, QoS, particular PRBs of the S-SR, or the cyclic shift of S-SR sequence. Furthermore, the configuration of S-SR between a pair of UEs may also include sidelink data transmission parameters such as recommended resource size (e.g. number of sub-channels), blind retransmission number, data QoS, MCS table, DMRS port, power control parameters (e.g. nominal power (P_{o,SL}) or SL pathloss scaling factor (α_{SL})).

In step 604, the slave UE may enter a reduced sensing mode (i.e. sleep mode) and therefore may not perform full sensing as it normally would. In the case of partial sensing, the slave UE may only monitor a subset of the available subtropics. The slave UE may enter the reduced power mode in order to reduce power consumption and extend battery life. As briefly discussed above, the slave UE may be power limited and as described further below may seek to reduce power consumption by offloading communication or sensing responsibilities to a less power limited master UE.

Next, in step 606, the slave UE may accumulate sidelink data (from a VUE, PUE, or other UEs for example) which should be re-directed to the master UE or other UEs. This sidelink data could contain information pertaining to different UEs in the network such as movement information (e.g., speed, acceleration, and/or brake status), position or location information (e.g., latitude and longitude, elevation, etc.), and other details.

In step 608, the slave UE may transmit a sidelink scheduling request (S-SR) to the master UE in order to transmit the sidelink data. More specifically, the slave UE may transmit the sidelink scheduling request to offload the task of determining scheduling resources that are useable by the slave UE to another device (e.g., the master device). Thus, the sidelink scheduling request (S-SR) may also be referred to as an offloading request, or may more aptly be characterized as a “sidelink resource determination offloading request”.

As discussed in FIG. 7, in response to receiving the S-SR from the slave UE, the master UE may determine a set of sidelink transmission resources for use by the second UE on the sidelink channel. This set of sidelink transmission resources may be sets of time, frequency, and/or code corresponding to the slot or physical resource block (PRB). Using this determined resource information, the master UE is able to communicate to the slave UE which resources it has recommended and if the resources are reserved or not reserved.

Moreover, after the slave UE sends the S-SR to the master UE, the slave UE may monitor the channel to receive the recommended resources from the master UE. This monitoring window may be pre-configured or configured per resource pool or configured by PC5-RRC. Additionally, the monitoring window size may depend on the S-SR periodicity and in some embodiments the monitoring window may be equal to the S-SR periodicity. Furthermore, if the slave UE does not receive a transmission from the master UE about recommended resources after the monitoring window, the slave UE may send another S-SR.

In step 610, the slave UE receives recommended resources from the master UE. The recommended resources received by the slave UE are in response to the scheduling request sent in 608. The master UE may utilize the SCI stage 2 format to indicate the source ID and destination ID of the recommended resources including the number of recommended resources, the time gap between the current slot and the first recommended slot, and the sub-channel index and sub-channel number of the first recommended slot. Using this information, the slave UE is able to more effectively communicate with the master UE or other UEs in regard to the sidelink data it is trying to send to the master UE or other UEs. Moreover, the master UE's recommendations may have already taken into account the possibilities of transmission/reception symbol collisions and recommended resources to avoid said collisions. This results in more efficient communication between the master and slave UEs. Importantly, the slave UE is able to receive and use these recommended resources without having to spend its own power or resources in sensing/determining these available resources

Additionally, further selection among the recommended resources is also possible. For instance, the slave UE may directly use all of the resources recommended by the master UE. In other aspects, the master UE may recommend N resource units, and the slave UE may randomly select M resource units where M is less than or equal to N. Moreover, in another aspect, the slave UE may select M resource units, from N recommended resources, based on its full or partial sensing. Additionally, in other aspects, the slave UE may not measure the sidelink channels during the monitoring window. In this example, if the slave UE does receive a transmission from the master UE about recommended resources within the monitoring window, the slave UE will send subsequent sidelink data using the recommended resources from the master UE.

Lastly, in step 612, the slave UE sends sidelink data based on or using recommended resources to the master UE. As discussed above, the sidelink data could contain information pertaining to different UEs in the network such as movement information (e.g., speed, acceleration, and/or brake status), position or location information (e.g., latitude and longitude, elevation, etc.), and other details.

### FIG. 7—Master UE Data Transmission

FIG. 7 illustrates an example procedure of master UE data transmission, according to some embodiments. More specifically, FIG. 7 shows operation of the master UE in response to receiving a scheduling request from the first UE, i.e., in response to the scheduling request (offloading request) transmitted in 608.

First, in step 702, the master UE may configure a sidelink scheduling request with a slave UE in order to establish the master/slave communications between them, as described above in 602. Thus, the master UE operation in 702 relates to the configuration of S-SR resources and is performed in conjunction with the slave UE operation in 602.

Furthermore, the configuration of S-SR between a pair of UEs may also include sidelink data transmission parameters configuration such as recommended resource size (e.g. number of sub-channels), blind retransmission number, data QoS, MCS table, DMRS port, power control parameters (e.g. nominal power (P_{o,SL}) or SL pathloss scaling factor (α_{SL})).

As described herein, the slave UE may be power limited and seek to reduce power consumption by offloading communication or sensing responsibilities to a less power limited master UE. More specifically, the establishment of resources for the sidelink scheduling request allows for inter-UE coordination between the master UE and slave UE so as to communicate and provide instructions with regard to resource allocation and sensing protocols. More specifically, the establishment of resources for the sidelink scheduling request allows the first UE (slave UE) to request the master UE to perform sidelink resource determination on its behalf.

Next, in step 704, the master UE may perform sensing (or partial sensing) in order to detect and identify nearby UEs and their respective available or unavailable resources. In the case of partial sensing, a UE may only monitor a subset of the subframes. By performing the sensing task normally associated with the slave UE, the master UE is able to alleviate the sensing responsibilities of the slave UE. This not only allows the slave UE to more efficiently conserve power but may also offer other improvements regarding enhanced communication reliability and reduced latency. In particular, the master UE may be able to perform more comprehensive sensing and thus may be able to generate a more reliable set or list of available (candidate) resources than would be possible by the first UE, since the master UE is not (or less) power constrained than the first UE.

In step 706, the master UE receives a sidelink scheduling request from the slave UE, which may be in conjunction with an attempt to schedule and receive sidelink data from the slave UE. In response to receiving the S-SR from the slave UE, the master UE may determine a set of sidelink transmission resources for use by the second UE on the sidelink channel, e.g., based on the sensing performed in 704. This set of sidelink transmission resources may be sets of time, frequency, and code corresponding to the slot or physical resource block (PRB).

In step 708, the master UE transmits information regarding the determined set of sidelink transmission resources to the slave UR. In other words, the master UE sends recommended resources to the slave UE. The master UE can provide this determined resource information to the slave UE in order to receive back desired sidelink communications or data. Moreover, the master UE may utilize the SCI stage 2 format to indicate the source ID and destination ID of one or more recommended resources including the number of recommended resources, the time gap between the current slot and the first recommended slot, and the sub-channel index and sub-channel number of the first recommended slot. For example, if the master UE had particular or prioritized information it was seeking to receive, the master UE may indicate to the slave UE certain preferred or recommended resources for the slave UE to utilize. In some aspects, the master UE may transmit a sidelink scheduling request to the slave UE in order to instruct or “wake-up” the slave UE to revert it back to a non-power saving mode where it can resume more full or partial sensing operations. In other embodiments, the determined set of sidelink transmission resources may be recommended resources but not reserved resources. Alternatively, the determined set of sidelink transmission resources, provided by the master UE to the slave UE, may be both recommended and reserved resources.

As briefly discussed above in regard to FIG. 6, after the master UE receives the S-SR from the slave UE, the master UE may recommend resources to the slave UE. The PDB (packet delay budget) of this transmission may be pre-configured per resource pool or configured by PC5-RRC and the resource selection window may be determined based on the PDB of this transmission. Additionally, the data priority of this transmission may depend on the data priority level indicated by the S-SR or may be pre-configured per resource pool or configured by PC5-RRC (similar to the PDB).

Moreover, the recommend resources provided by the master UE may allow the slave UE to perform further selection among the recommended resources. For instance, the master UE may recommend a certain number of resources N in which the slave UE may directly use all of the resources recommended by the master. Alternatively, the slave UE may randomly select M resource units where M is less than or equal to N or the slave UE may select M resource units, from N recommended resources, based an its full or partial sensing. Furthermore, if the master UE sends a transmission to the slave UE about recommended resources within the monitoring window, the slave UE may send subsequent sidelink data using the recommended resources from the master UE.

Finally, in step 710, the master UE receives sidelink data on recommended resources from the slave UE. As discussed above, this received sidelink data may include various data, such as movement or motion information of the slave UE (e.g., speed, acceleration, and/or brake status), position or location information of the slave UE (e.g., latitude and longitude, elevation, etc.), and other details.

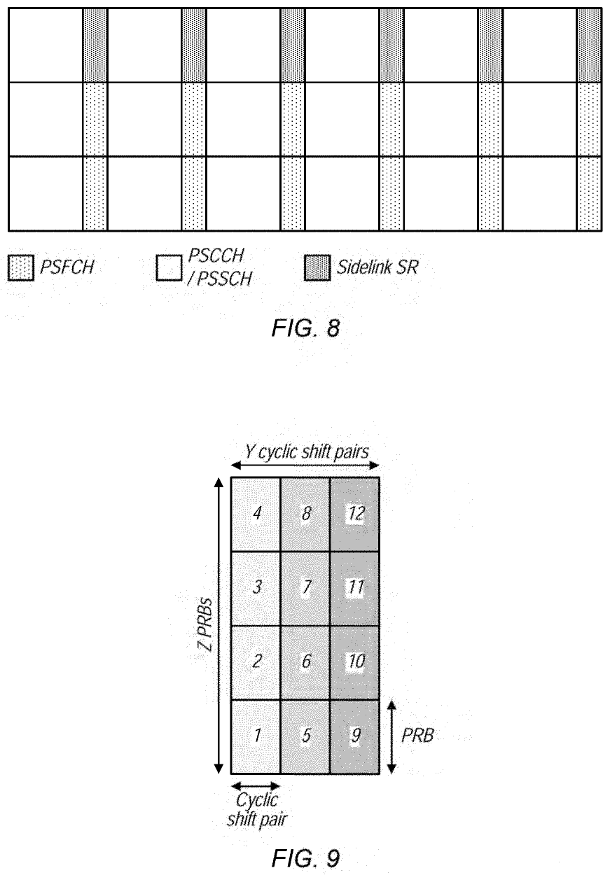

### FIG. 8—Sidelink Scheduling Request Signal Structure

FIG. 8 illustrates an example structure of a sidelink scheduling request (S-SR) signal, according to some embodiments. Specifically, FIG. 8 illustrates the resources and structure of the S-SR signal system design i.e., how the S-SR signal can be incorporated into other signaling, such as in the PSFCH (Physical Sidelink Feedback Channel). With regard to the resources of the S-SR, the last symbols of a slot at certain frequency may be un-reserved for PSFCH and hence may be repurposed for use in transmitting the S_SR signal. These symbols may be frequency division multiplexed (FDM) with PSFCH resources and may have same or different periodicity from other PSFCH resources. Additionally, transmission and reception of an S-SR may consume less power than transmission and reception of PSCCH or PSSCH signals.

In regard to structure, each S-SR signal may occupy one PRB and two symbols (similar to a PSFCH). Additionally, the sequence (with a cyclic shift) may be selection based (similar to NR PUCCH format 0). Furthermore, the S-SR signal cyclic shifts may be based upon code domain multiplexing. In some embodiments, the S-SR resource configuration may be encoded as a cyclic shift of the S-SR corresponding to all ACK-only sequence (i.e., a single sequence with a pre-configured cyclic shift). In this example, the transmission of the sequence may indicate a positive sidelink SR and the absence or lack of transmission of the sequence may indicate a negative sidelink SR. According to other aspects, the S-SR resource configuration may be encoded as a cyclic shift pair of the S-SR for an ACK/NACK sequence (i.e. two sequences with a pair of pre-configured cyclic shifts). In this example, the transmission of the sequence with a cyclic shift may indicate a positive sidelink SR whereas the transmission of a sequence with the other cyclic shift may indicate a negative sidelink SR.

In further regard to structure, the S-SR resource configuration may also be encoded as a configuration index which indicates a certain sequence of the S-SR. In this example, multiple sequences could be configured with multiple cyclic shifts and each sequence may be associated with a configuration index. Furthermore, a sequence or sequence pair of an S-SR may be associated with a configuration which corresponds to sidelink data transmissions parameters. Moreover, each configuration index may correspond to sidelink data transmission parameters such as resource periodicity, number of sub-channels, and/or number of resources. In other aspects, each configuration index may correspond to a certain data QoS or different cast type. In some embodiments, a combination of sequences indicated by a configuration index with sequences with a pair of pre-configured cyclic shifts (i.e. the ACK/NACK sequence) may also be supported by the S-SR structure.

### FIG. 9—Sidelink Scheduling Request Signal Frequency and Code Resources

FIG. 9 illustrates the frequency and code resources of a sidelink scheduling request (S-SR) signal, according to some embodiments. More specifically, FIG. 9 illustrates that the frequency and code resources of an S-SR depend on the ID of the UE being scheduled (i.e. the destination ID) and/or the ID of the scheduling UE (i.e. the source ID). Moreover, when determining the S-SR resource, the first step may be to combine the source ID and destination ID. In some aspects, this may involve concatenating the destination ID and source ID. In other aspects, this may involve concatenating the source ID and destination ID. In some aspects, the first step when determining the S-SR resource may involve combining the source ID and destination ID through use of an exclusive or (XOR) operation.

The second step in determining the S-SR resource may involve calculating the total number of frequency and code domain S-SR resources. In some embodiments, this may involve frequency first, code second indexing. In other aspects this may involve code first, frequency second indexing.

Next, the frequency-code domain S-SR resource ID may be determined by performing modulo operations on the combined ID from the first step described above by the total number of frequency-code domain S-SR resources.

Lastly, the UE may then send or receive the S-SR on the determined S-SR resource ID.

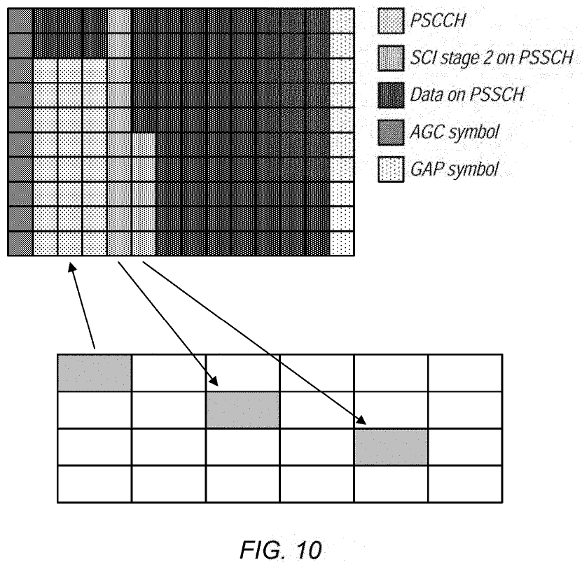

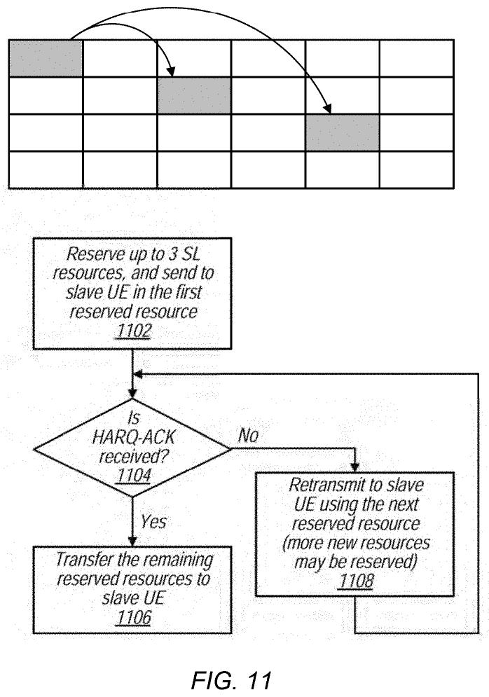

### FIG. 10—Master UE Recommending Non-Reserved Resources

FIG. 10 illustrates an example of a master UE providing a slave UE with recommended but not reserved resources, according to some embodiments. For instance, after the master UE receives an S-SR from a slave UE, the master UE may then transmit signaling to indicate recommended resources based on the master UE's sensing operations. Additionally, to avoid half-duplex issues of PSSCH reception and transmission, the master UE may transmit signaling to indicate recommended resources based on the master UE's existing scheduling. Furthermore, the recommended resources transmitted by the master UE may be encoded and delivered as PSSCH data.

For example, as shown in FIG. 10, the first resource box (top-left) may contain PSCCH data as indicated by the arrow on the left. This PSCCH data may contain the resource reservation information used to indicate the resources of solely the first resource box. This resource reservation information would not be used to indicate the other two resource boxes.

On the other hand, the SCI stage 2 on PSSCH boxes may contain the resource recommendation information used to indicate the other two resource boxes (middle and right). The two arrows on the right in FIG. 10 illustrate the resource recommendation information contained in the SCI stage 2 on PSSCH boxes. In other words, the two arrows on the right may correspond to the master UE indicating resources via SCI stage 2 on PSSCH that have been recommended but are not reserved. Since these recommendation resources are not reserved (in PSCCH), other UEs may attempt to use these resources.

In other aspects, the recommended resources transmitted by the master UE may be delivered in SCI stage 2 format. Moreover, the SCI stage 2 format may be used to indicate the source ID and destination ID of the recommended resources. Additionally, up to three separate resources may be indicated in the SCI stage 2 format including the number of recommended resources, the time gap between the current slot and the first recommended slot, and the sub-channel index and sub-channel number of the first recommended slot. Moreover, if the SCI stage 2 format indicates more than one recommended resource, the remaining resources are indicated as FRIV (frequency resource indicator value) and TRIV (time resource indicator value).

Additionally, other sidelink data transmission parameters can be indicated in SCI stage 2 in order to alleviate the slave UE's operations. For example, the modulation and coding scheme (MCS), the MCS table, DMRS ports as well as HARQ feedback may be always enabled for this type to SCI stage 2. Additionally, channel busy radio (CBR) related information such as CBR level and power control information (e.g. sidelink pathloss sidelink pathloss scaling factor (α_{SL})) may be indicated or the power level may be directly transmitted.

### FIG. 11—Master UE Recommending Reserved Resources

FIG. 11 illustrates an example of a master UE providing a slave UE with recommended and reserved resources in addition to the transfer of ownership of reserved resources, according to some embodiments. For instance, after the master UE receives an S-SR from a slave UE, the master UE may then transmit signaling to indicate recommended resources based on the master UE's sensing operations. These recommended resources may also be reserved resources. In some embodiments, the resource reservation information may only be contained in PSCCH data. In this example, another UE would receive the PSCCH in order to know which resources are reserved.

Furthermore, the master UE may utilize SCI stage 1 to indicate the one or more reserved resources for the slave UE's transmission as shown in step 1102. Additionally, QoS may be sent as the configured sidelink data QoS and an additional bit to indicate the owner of the reserved resources may also be exchanged between the master UE and slave UE.

In order to transfer ownership of the reserved resources, after receiving an HARQ-ACK in step 1104, the roaster UE may determine that the reserved resources to be used by the slave UE are the reserved resources in which the master UE may receive data on. The master UE may then transfer the remaining reserved resources to the slave UE (i.e. transfer of ownership) as shown in step 1106. In doing so, the slave UE may then transmit the appropriate sidelink data using the newly transferred reserved resources. On the other hand, if a HARQ-NACK is received, the master UE may determine that the reserved resources will not be used by the slave UE. In this case, the master UE may send another transmission containing, information which may include more recommended and reserved resources to the slave UE. In other words, as shown in step 1108, the master UE may send an additional transmission containing information (in which more new resources may be reserved) to the slave UE using the next reserved resource.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 104) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A user equipment (UE), comprising:
at least one antenna;
a radio operably coupled to the at least one antenna; and
a processor operably coupled to the radio;
wherein the UE is configured to:
transmit, a scheduling request to a second UE, wherein the scheduling request is configured to cause the second UE determine a set of sidelink transmission resources for use by the UE;
receive information regarding a determined set of sidelink transmission resources from the second UE, wherein the set of sidelink resources are determined based on the transmitted scheduling request;
transmit sidelink communications using at least a subset of the determined set of sidelink transmission resources.

2. The UE of claim 1,
wherein the determined set of sidelink transmission resources are recommended and are not reserved resources.

3. The UE of claim 1,
wherein the determined set of sidelink transmission resources are recommended and reserved resources.

4. The UE of claim 3,
wherein the UE is configured to receive one or more of the reserved resources from the second UE based at least in part in response to transmitting a HARQ-ACK to the second UE.

5. The UE of claim 3,
wherein the UE is further configured to, in response to transmitting a HARQ-NACK to the second UE, receive information regarding the determined set of sidelink transmission resources from the second UE using one or more additional reserved resources.

6. The UE of claim 1, wherein the UE is further configured to:
transmit configuration information to the second UE, wherein the configuration information specifies transmission resources used in transmission of the scheduling request.

7. The UE of claim 6, wherein the UE is configured to encode the scheduling request as a cyclic shift of the S-SR corresponding to an ACK-only sequence.

8. The UE of claim 6, wherein the UE is configured to encode the scheduling request as a cyclic shift pair of the S-SR corresponding to an ACK/NACK sequence.

9. The UE of claim 6, wherein the UE is configured to encode the scheduling request as a configuration index which indicates a certain sequence of the S-SR, wherein each sequence of the S-SR is associated with a configuration.

10. The UE of claim 1, wherein the UE monitors a wireless channel for arrival of the determined set of sidelink transmission resources.

11. A baseband processor configured for use in a user equipment (UE), comprising:
processing circuitry configured to:
transmit a scheduling request to a second UE, wherein the scheduling request is configured to cause the second UE to determine a set of sidelink transmission resources for use by the UE;
receive information regarding a determined set of sidelink transmission resources from the second UE, wherein the set of sidelink resources are determined based on the transmitted scheduling request;
transmit sidelink communications using at least a subset of the determined set sidelink transmission resources.

12. The baseband processor of claim 11,
wherein the determined set of sidelink transmission resources are recommended and are not reserved resources.

13. The baseband processor of claim 11, wherein the determined set of sidelink transmission resources are recommended and reserved resources.

14. The baseband processor of claim 13,
wherein the baseband processor is further configured to, in part in response to transmitting a HARQ-ACK to the second UE, receive one or more of the reserved resources from the second UE.

15. The baseband processor of claim 3,
wherein the baseband processor is further configured to, in response to transmitting a HARQ-NACK to the second UE, receive information regarding the determined set of sidelink transmission resources from the second UE using one or more additional reserved resources.

16. The baseband processor of claim 11, wherein the baseband processor is further configured to:
transmit configuration information to the second UE, wherein the configuration information configures transmission resources used in transmitting the scheduling request.

17. The baseband processor of claim 16, wherein the baseband processor is configured to encode the scheduling request as a cyclic shift of the S-SR corresponding to an ACK-only sequence.

18. The baseband processor of claim 16, wherein the baseband processor is configured to encode the scheduling request as a cyclic shift pair of the S-SR corresponding to an ACK/NACK sequence.

19. The baseband processor of claim 16, wherein the baseband processor is configured to encode the scheduling request as a configuration index which indicates a certain sequence of the S-SR, wherein each sequence of the S-SR is associated with a configuration.

20. The baseband processor of claim 11, wherein the baseband processor is configured to monitor a wireless channel for arrival of the determined set of sidelink transmission resources.

21. A user equipment (UE), comprising:
at least one antenna;
a radio operably coupled to the at least one antenna; and
a processor operably coupled to the radio;
wherein the UE is configured to;
receive a scheduling request from a second UE, wherein the scheduling request is configured to cause the UE to determine a set of sidelink transmission resources for use by the second UE on a sidelink channel;
determine a set of sidelink transmission resources for use by the second UE in response to the received scheduling request;
transmit information regarding the determined set of sidelink transmission resources to the second UE, wherein the information regarding the determined set of sidelink transmission resources is useable by the second UE in transmitting on the sidelink channel.

22. The UE of claim 21,
wherein the UE is configured to determine the set of sidelink transmission resources by sensing communication traffic on the sidelink channel.

23. The UE of claim 21,
wherein the it is configured to determine the set of sidelink transmission resources based on an existing resource schedule maintained by the UE.

24. The UE of claim 21,
wherein the set of sidelink transmission resources comprise recommended resources.

25. The UE of claim 21,
wherein the set of sidelink transmission resources comprise reserved resources.

26 The UE of claim 25,
wherein the UE is further configured to, in response to receiving a HARQ-ACK from the second UE, transfer one or more of the reserved resources to the second UE.

27. The UE of claim 25,
wherein the UE is further configured to, in response to receiving a HARQ-NACK from the second UE, retransmit the information regarding the determined set of sidelink transmission resources to the second UE using one or more additional reserved resources.

28. The UE of claim 21,
wherein the UE is configured to transmit information regarding the determined set of sidelink transmission resources on a physical sidelink shared channel or on a sidelink control information (SCI).

29. A baseband processor configured for use in a user equipment (UE), comprising:
processing circuitry configured to:
receive a scheduling request from a second UE, wherein the scheduling request is configured to cause the UE to determine a set of sidelink transmission resources for use by the second UE on a sidelink channel;
determine a set of sidelink transmission resources for use by the second UE in response to the received scheduling request;
transmit information regarding the determined set of sidelink transmission resources to the second UE, wherein the information regarding the determined set of sidelink transmission resources is useable by the second UE in transmitting on the sidelink channel.

30. The baseband processor of claim 29,
wherein the baseband processor is configured to determine the set of side ink transmission resources based on an existing resource schedule maintained by the UE.

31. The baseband processor of claim 29,
wherein the set of sidelink transmission resources comprise recommended resources.

32. The baseband processor of claim 29,
wherein the set of sidelink transmission resources comprise reserved resources.

33. The baseband processor of claim 32,
wherein the UE is further configured to, in response to receiving a HARQ-ACK from the second UE, transfer one or more of the reserved resources to the second UE.

34. The baseband processor of claim 32,
wherein the UE is further configured to, in response to receiving a HARQ-NACK from the second UE, retransmit the information regarding the determined set of sidelink transmission resources to the second UE using one or more additional reserved resources.

34. The baseband processor of claim 29,
wherein the baseband processor is configured to transmit information regarding the determined set of sidelink transmission resources on a physical sidelink shared channel or on a sidelink control information (SCI).
